(19) United States
(12) Patent Application Publication
(10) Pub. No.: US 2014/0375796 A1
(43) Pub. Date: Dec. 25, 2014

(54) Measuring Apparatus for Checking an Approach Path Indicator for the Landing of an Aircraft, and Corresponding Checking Device

(71) Applicant: FB Technology, Evry (FR)

(72) Inventors: Lionel Le Cam, Verrieres Le Buisson (FR); Basile Morancay, Saint-Arnoult en Yvelines (FR); Amine Iraqui-Houssaini, Villejuif (FR); Jean-Etienne Longy, Versailles (FR)

(73) Assignee: FB Technology, Evry (FR)

(21) Appl. No.: 14/350,731

(22) PCT Filed: Oct. 10, 2012
(86) PCT No.: PCT/EP2012/070080

§ 371 Date: Apr. 9, 2014

(30) Foreign Application Priority Data
Oct. 10, 2011 (FR) 1159139

(51) Int. Cl. G01J 1/42; H04N 5/30

(52) U.S. Cl. CPC G01J 1/4257; H04N 5/30; G01J 2001/4247
USPC 348/135

(57) ABSTRACT

A mobile apparatus measures the characteristics of a light beam emitted by a light unit, presenting at least two angular portions of different colors. The apparatus includes a support that enables the position of a measuring set to vary. The measuring set including a single orientable camera provided with a zoom capable of assuming at least a first low-magnification position for providing reduced magnification and a wide angle of field enabling the detection of the position of the light unit to orient the camera precisely in its direction, and a second position of high magnification enabling the taking of an image of the light unit enabling an analysis of the characteristics of a light beam emitted by a light unit.

### 1. CROSS-REFERENCE TO RELATED APPLICATIONS

This Application is a Section 371 National Stage Application of International Application No. PCT/EP2012/070080, filed Oct. 10, 2012, which is incorporated by reference in its entirety and published as WO 2013/053773 on Apr. 18, 2013, not in English.

### 2. FIELD OF THE INVENTION

The present invention relates to a measuring apparatus for verifying the efficient operation of a visual approach slope or approach path indicator, to enable aircrafts approaching a runway in order to land thereon to be guided on the path most suited for landing.

The invention also pertains to a checking device implementing this measuring apparatus.

The invention pertains more particularly to devices enabling the checking of systems known as “PAPI” (Precision Approach Path Indicators) or “APAPI” (Abbreviated Precision Approach Path Indicators).

### 3. PRIOR ART

### Visual Approach Slope Indicators

Airport runways are surrounded with visual indicators giving aircraft pilots the indications by which they can land in the right conditions.

Among these indicators, visual approach slope indicators give the indications needed to place the aircraft on the ideal approach slope relative to the runway in order to land thereon. This visual landing aid is operational day and night.

Known visual approach slope indicators include especially the “PAPI” (“Precision Approach Path Indicator”) devices and the “APAPI” (Abbreviated Precision Approach Path Indicator”) devices.

“PAPI” devices generally comprise four identical light units (here below called “PAPI light units), each emitting red light below a certain angle and white light above this angle. These four light units are borne by a horizontal bar situated beside the runway, generally to the left, at the level of the landing runway that is being headed towards. The four light units are placed on the bar in such a way that the pilot of an aircraft approaching the track sees the four luminous points beside one another.

All the light units are positioned with different elevation angles, the angle increasing from the outside light unit, which is at the greatest distance from the runway, to the light unit closest to the runway. The term “elevation angle” designates the angle formed by the optical axis of the beam emitted by the light unit, through which passes the transition between the white part and the red part of the beam, with the horizontal.

The difference between the elevation angles of two consecutive light units is generally equal to 20 arc-minutes. Since the transition between the red light beam emitted by each light unit below a certain angle and the white light beam emitted by the light unit above this angle is very precise, normally not exceeding 3 arc-minutes, the pilot of the aircraft approaching the runway sees each of the red or white lights, depending on his altitude. FIGS. 1A, 1B and 2A to 2E thus represent the working of a set of PAPI light units.

FIG. 1A is a schematic top view of one end of the runway 1 of the airport. Beside this runway, at the level where it is planned that the aircraft will land, there is placed a PAPI device 2 comprising four light units 21, 22, 23 and 24 borne by a same bar, and each emitting light beams oriented towards aircraft approaching the runway.

FIG. 1B is a schematic side view of the runway 1 and of the PAPI device 2. The optical axes 210, 220, 230 and 240, associated respectively with the beams emitted by the light units 21, 22, 23 and 24 of the PAPI device 2, are represented in this figure. As can be seen in this figure, each of the light units 21 to 24 has a different elevation angle that increases between the light unit 21 and the light unit 24.

The elevation angles of these optical axes are distributed about an angle corresponding to the optimum approach path 3 of an aircraft getting ready to land.

For example, if we consider an approach angle θ corresponding to the optimum approach path 3, the light unit 21 is positioned so that its optical axis 210 forms a elevation angle that is smaller than the angle θ by 30 arc minutes, the light unit 22 is positioned so that its optical axis 220 forms a elevation angle that is smaller than the angle θ by 10′, the light unit 23 is positioned in such a way that its optical axis 230 is greater than the angle θ by 10′, and the light unit 24 is positioned in such a way that its optical axis 240 is greater than an angle θ by 30′. It must be noted that the angles shown in FIG. 1B do not correspond to the real angles but have been exaggerated in order to facilitate the reading of the figure.

The pilot of an aircraft approaching the runway of the airport sees each PAPI light unit in white or red, depending on whether he is above or below the optical axis of this light unit. FIGS. 2A to 2E are schematic representations of the view that a pilot has of the runway 1 and of the PAPI device associated with it in the different possible configurations.

FIG. 2A represents the view from an aircraft 41 situated below the optical axes of all the PAPI light units. The pilot of this aircraft sees the four light units 21 to 24 of the PAPI device 2. The light units are red. This indicates that it is too low relative to the optimal approach path 3.

FIG. 2B represents the view from an aircraft 42 situated above the optical axis 210 of the light unit 21 but below the optical axes of the light units 22 to 24. The pilot of this aircraft sees the white light unit 21 and the red light units 21 to 24. This tells him that he is slightly too low relative to the optimal approach path 3.

FIG. 2C represents the view from an aircraft 43 situated above the optical axes 210 and 220 of the light units 21 and 22 but below the optical axes 230 to 240 of the light units 23 and 24. The pilot of this aircraft sees the white light units 21 and 22 and the red light units 23 and 24. This informs him that his aircraft is on the optimal approach path 3.

FIG. 2D represents the view from an aircraft 44 situated above the optical axes 210, 220, 230 of the light units 21, 22 and 23, but below the optical axis 240 of the light unit 24. The pilot of this aircraft sees the white light units 21 and 23 and the red light unit 24. This informs him that his aircraft is slightly above the optimum approach path 3.

FIG. 2E represents the view from an aircraft 45 situated above the optical axes of the light units 21 to 24. The pilot of this aircraft sees the 4 lamps 21 to 24 of the device PAPI colored white. This informs him that his aircraft is too high relative to the optimum approach path 3.

Thus the PAPI device makes it easy to provide a reliable indication to the pilots about their altitude relative to an optimum approach path.

It must be noted that, in certain cases, symmetrical PAPI devices can be positioned on either side of the runway. A simplified device called APAPI can also be implemented on other runways. Only two light units, of the same type as those used in the PAPI devices, are implemented in the APAPI device, and are inclined in such a way that their optical axes are respectively higher and lower than the optimum approach path.

### Architecture of a PAPI Light Unit

FIG. 3 represents the typical architecture of a projector of a PAPI light unit. This projector comprises a halogen lamp 201 with white light and a reflector 202 enabling the emitted light beam to be oriented in the direction represented by the optical axis 203. The light rays situated above this optical axis pass through a red filter 204 placed in the plane of a lens 205 forming the output of the projector. The light rays are then collimated by the lens 205 thus generating (white/red) color transition. The different elements of the projector (reflector, lamp, lens, red filter) must be perfectly aligned so that the optical axis of the lens coincides with the mechanical axis of the system.

In the event of a misalignment of the red filter, the transition between the colors white and rend can be offset vertically, upwards or downwards, or can be inclined. In all these cases, this misalignment falsifies the information delivered to the pilot. This creates a risk for the safety of the aircraft.

Besides, when the red filter 204 is offset longitudinally relative to the focal plane of the output lens 205, the color transition between white and red in the light beam emitted by the light unit is not perfectly collimated. This leads to a transition zone between the two colors greater than that stipulated by the standards

Finally, the precise orientation of the projector and the lamp, the power of the beam and the chromatic characteristics of the white and red zones of each beam must also be adjusted so as to provide the pilot with precise and accurate information.

To carry out a precise setting of the different characteristics of each projector of a PAPI or APAPI system, it is important to be able to measure the characteristics of the emitted beam with precision so as to check their compliance with the prevailing standards. Such checks at regular intervals are stipulated by airport supervisory authorities.

There are several known methods for checking the approach path indicators. According to one of them, a theodolite placed at the level of a light unit measures the position of an aircraft moving in the runway approach zone, the pilot of which observes the color of the light units. According to another known method, this theodolite measures the position of a sighting piece placed a few meters before the light units, at the level of the color transitions. These methods are complicated to implement and do not really give satisfaction.

There is also a system, known from the document US 2011/0032519, for detecting the inclination of light sources that can be placed before a PAPI type light unit to measure its inclination. This system is relatively complex inasmuch as it requires two cameras, one enabling a rough setting of the orientation of the system in order to take position in the beam before the second camera makes the measurements. Besides, while it enables a precise measurement of the angle of inclination of the light unit, it does not however make it possible to measure the luminous intensity of this light unit with sufficient efficiency as required, however, is required by the prevailing standards. Indeed, the camera used to make this measurement gives only an imprecise evaluation of this luminosity.

### 4. SUMMARY OF THE INVENTION

An exemplary embodiment of the present application relates to a mobile apparatus for measuring the characteristics of a light beam emitted by a light unit, presenting at least two angular portions of different colors, said apparatus comprising a support that enables the position of a measuring set to vary wherein, according to the invention, said measuring set comprises a single orientable camera, equipped with a zoom element capable of taking at least two positions:
a first position of low magnification, offering a wide field angle, enabling the detection of the position of the light unit to orient the camera precisely in its direction;
a second position of high magnification, enabling the taking of an image of the light unit, enabling an analysis of the characteristics of a light beam emitted by a light unit.

Thus, this single camera of the mobile apparatus can carry out two tasks clearly distinct from each other, one consisting in locating the light unit to enable the precise positioning of the measuring set and the camera, and the other consisting in taking an image of the light unit enabling a precise analysis.

These two tasks were fulfilled in the prior art by two different components since those skilled in the art thought that the characteristics required of each of these components were mutually contradictory. This resulted in high complexity in the prior art systems.

On the contrary, the mobile apparatus according to the invention is of far simpler construction.

Advantageously, the measuring set comprises at least one inertial platform fixed to said camera, enabling its inclination to be measured.

This inertial platform which can be replaced, if necessary, by a simple gyroscope, enables a particularly precise measurement of the angle formed by the camera and therefore, when the camera is on the optical axis of a light beam and oriented towards the light unit, of the orientation of this beam.

Preferably, said measuring set comprises at least one luminosity sensor distinct from said camera.

This combination of a camera and luminosity sensors in the measuring set enables precise and reliable measurement of the photometrical characteristics of the light beam.

Advantageously, said measuring set comprises a case containing said camera.

Preferably, said luminosity sensors are placed on telescopic brackets supported by said case.

These sensors can thus be distributed in different points of the light beam. Since the case is mobile, it can drive the sensors in different directions to take a large quantity of measurements that can be used to prepare a light intensity diagram (or luminance) diagram for the light unit being checked.

Advantageously, said support is constituted by a stand supporting a system for the motor-driven shifting of said measuring set.

This motor-driven shifting system enables the measuring set to be shifted in a plane substantially perpendicular to the optical axis of the beam.

The present invention also pertains to a device for checking a light unit comprising:
a mobile measurement apparatus, and
a computer for processing data from the mobile measuring apparatus, and an interface with an operator.

Advantageously, said mobile measurement apparatus and said computer communicate by a radio link. This radio link can be, for example, of a WiFi type.

Preferably, said computer accesses a database comprising information relating to each of the light units to be checked.

### 5. LIST OF FIGURES

The present invention will be understood more clearly from the following description of a preferred embodiment, given by way of a non-exhaustive illustration and accompanied by figures of which:

FIGS. 1A and 1B, commented hereinabove, schematically represent an airport runway equipped with a PAPI system;

FIGS. 2A to 2E, commented hereinabove, schematically represent the view from an aircraft approaching an airport runway equipped with a PAPI system;

FIG. 3, commented hereinabove, schematically represents the components of a PAPI light unit;

FIG. 4 is a side view of a PAPI light unit before which there is positioned a measuring set according to one embodiment of the invention;

FIGS. 5A and 5B respectively represent a front view and a rear view of the measuring set of FIG. 4;

FIG. 6 represents a camera of the type integrated into the case of the measuring equipment of FIG. 4;

FIG. 7 is a schematic representation of the architecture of a system for checking an approach path indicator according to one embodiment of the invention.

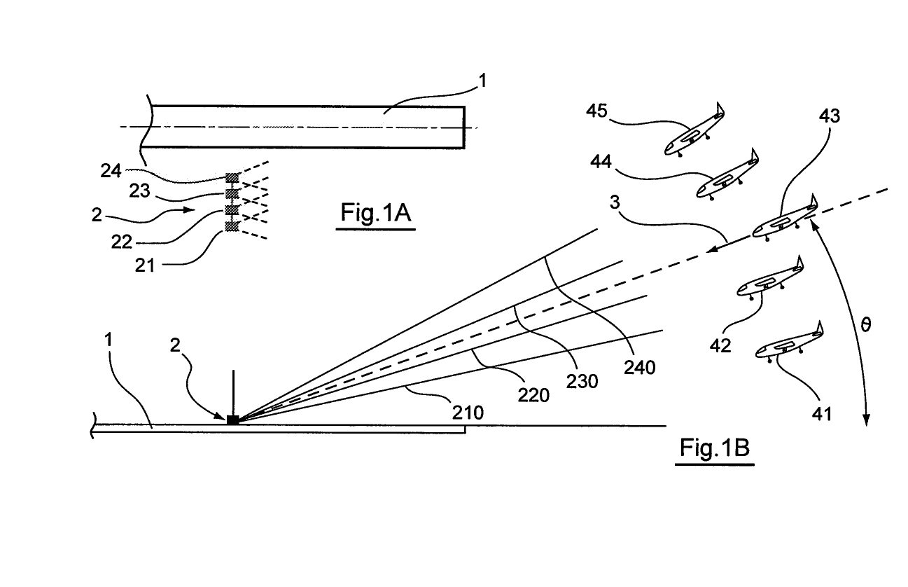

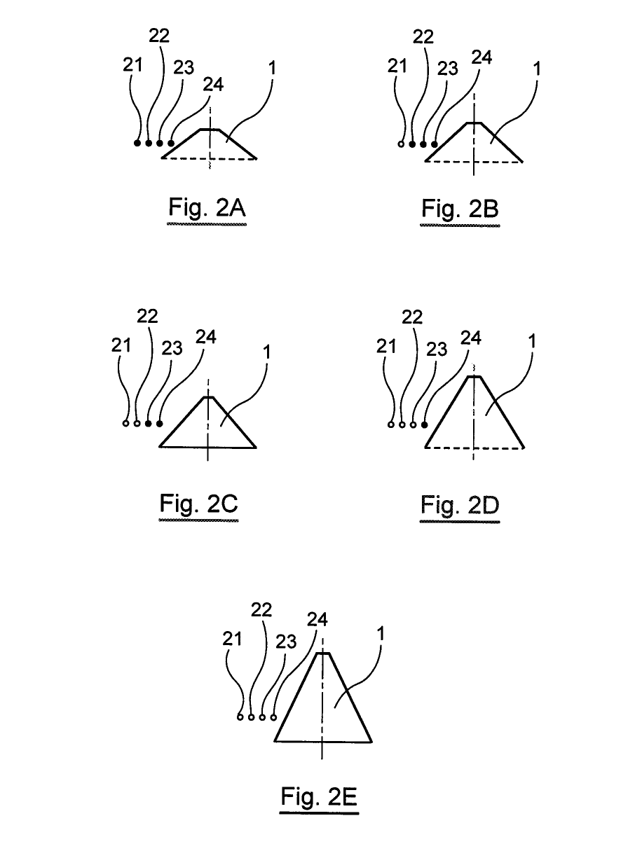

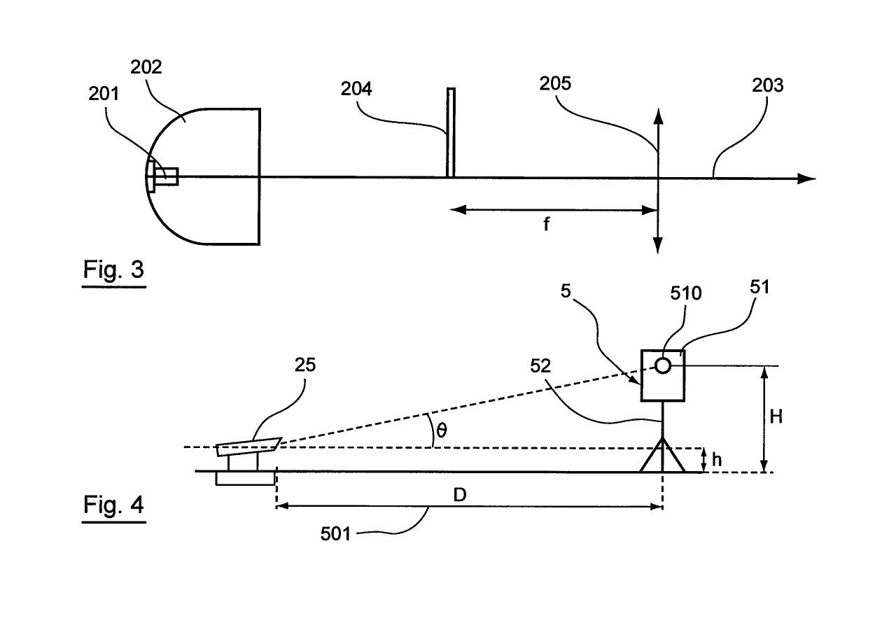

### 6. DESCRIPTION OF ONE EMBODIMENT

### Position of the Measuring Apparatus Facing the Light Units

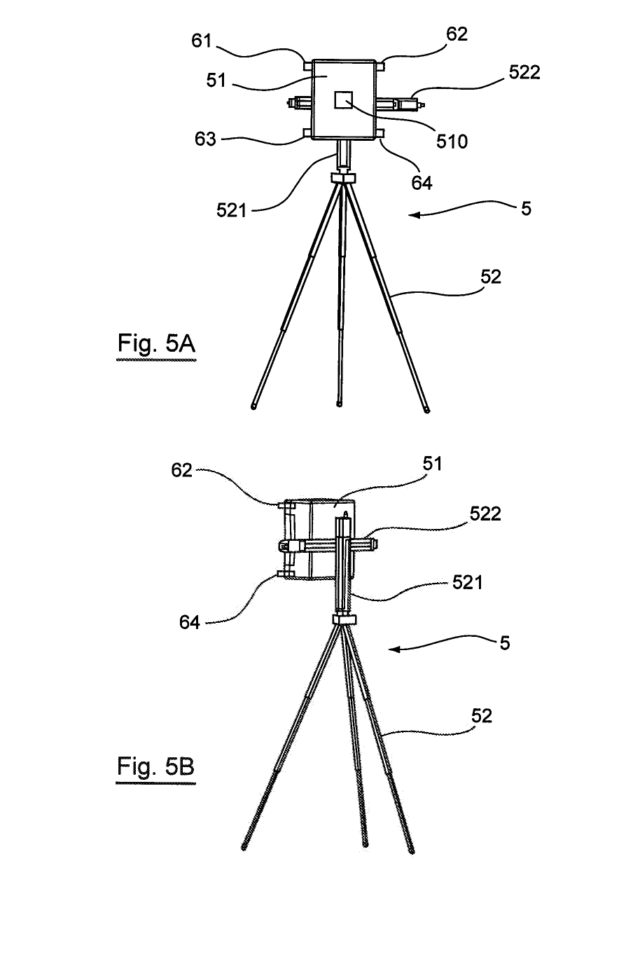

FIG. 4 is a schematic side view of a measuring apparatus 5, forming part of a system for checking an approach path indicator, positioned to check a light unit 25 of a PAPI type device. The measuring apparatus 5, which is represented in greater detail in FIGS. 5A and 5B, comprises a case 51, supporting a measuring set, borne by a tripod 52. It is placed at a predetermined distance 501 from the light unit 25, for example a distance of 5 or 10 meters, in the light beam emitted by this light unit.

### Prepositioning of the Case in the Optical Axis by Adjustment of the Tripod

The case 51 has a viewing aperture 510, constituted for example by a glazed zone in the wall of the case 51 which is pointed toward the light unit 25 to be checked. The height of the tripod 52 is adjustable so that this viewing aperture 510 can be placed at the desired height. Preferably, this viewing aperture 510 is positioned so as to be at the level of the theoretical optical axis of the light unit to be checked. For example, on flat ground, the height of the tripod 52 is chosen in such a way that the viewing aperture 510 is at a height H from the ground, determined as follows:

H=D*tan(θ)+h

with:
D: distance 501 between the light unit 25 and the apparatus 5;
θ: the theoretical elevation angle of the optical axis of the light unit 25;
h: height of the light unit 25 relative to the ground.

### Single Camera in the Case

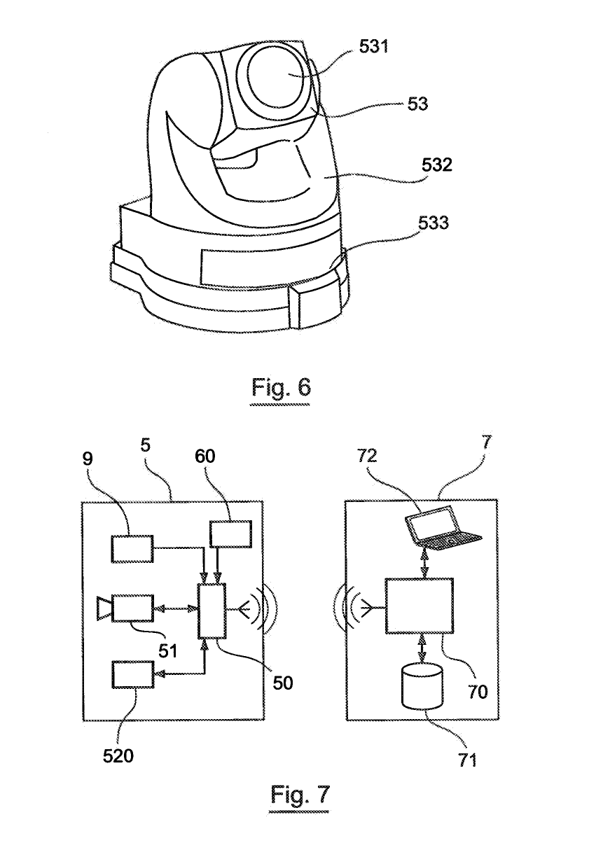

The case 51 contains a single camera 53 of the type shown in FIG. 6, the objective 531 of which is situated behind the viewing aperture 510 of the case 51. This camera is mounted in a pivoting manner about an axis that is horizontal relatively to an intermediate support 532, itself pivoting about a vertical axis relative to a pedestal 533, so as to be capable of modifying the elevation angle and the azimuth of the camera. Each of these pivoting motions is driven by a system integrated into the camera unit providing for the automatic control and checking of the motions of the camera during the acquisitions. Preferably, these motions are controlled by a computer program enabling the camera to be pointed automatically towards the light unit to be checked, once this light unit has been identified on the images picked up by the camera.

Advantageously, the chosen camera comprises a motor-driven objective offering a zoom×18 with automatic focusing, a play of elevation angle between −30° and +90°, and a range of azimuth of −170° to +170°. This camera is of a digital type and preferably has a CCD (charge-coupled device) type sensor.

### Photometric Sensors Associated with the Case

Besides, as shown in FIGS. 5A and 5B, photometric sensors of luminosity 61, 62, 63 and 64, comprising for example photodiodes, placed in the case 51 enable the measurement of the illuminance (expressed in lux) coming from the light unit 25 to be checked. Since the distance between the sensors 61, 62, 63 and 64 and the light unit 25 is predetermined and known, these measurements of illuminance make it possible to directly compute the luminous intensity of the light unit 25, expressed in candelas. Preferably, several of these sensors, for example four of them, are attached to different points of the case, for example in proximity to the four corners of the case, in order to measure the illuminance at several points of the light beam. Preferably and advantageously, these sensors will be positioned on telescopic brackets. It is thus possible to place them at the desired distance from the case for the measurements, and to fold them for transporting the measuring apparatus.

### System for the Motor-Driven Shifting of the Case

The case 51 is fixed to the tripod 52 by a motor-driven shifting system comprising a guideway or vertical rail 521 fixed to the tripod 52, in which a slider linked to the case 51 can slide. These rails 521 and 522 enable the shifting of the case 51 in the vertical and horizontal directions, in a plane appreciably perpendicular to the optical axis of the beam emitted by the light unit 52. Advantageously, they provide an amplitude of shifting by the case 51 of the order of 40 cm in the vertical and horizontal directions.

These shifts along the rails are controlled by electric servomotors. Preferably, for the initial positioning of the measuring apparatus facing the PAPI light unit to be controlled, before the first measurements, the case 51 occupies a median position corresponding appreciably to the middle of each of the rails 521 and 522.

### Precise Positioning of the Camera

Once the measuring apparatus has been set up, the camera 53 starts taking shots of the images of the light unit to be checked, its zoom element being in a position that offers low magnification and a wide field angle. The case 51 is then shifted automatically by the motor-driven shifting system so as to obtain a precise positioning of the viewing aperture 510, and therefore of the objective 531 of the camera 53, on the optical axis of the beam emitted by the light unit 25 to be checked. The image picked up by the camera 53 is analyzed during these shifts to direct the case 51 towards a position precisely aligned with the optical axis of the light unit 25, and to precisely identify this correct position.

More specifically, the case 51 is well positioned when:
the image of the light unit 25 picked up by the camera 53 corresponds to a disk;
the transition between the red and white beam parts is truly in the middle of the image of the light unit 25 picked up by the camera.

If the transition between the red and white beam parts is inclined relative to the horizontal, then the positioning of the red filter in the projector of the light unit 25 must be adjusted before continuing with the precise positioning of the case 51. A message is communicated for this purpose to the operator making the check.

### Readings of the Elevation Angle and of the Image of the Light Unit

When the case 51 is in the right position, in which the camera 53 is located precisely in the optical axis of the light unit 25, at the transition between red and white, the camera 53 zooms in on this light unit, in order to have a precise image of it, and is oriented precisely in the direction of this light unit by the support 532. A gyroscopic platform fixed to the camera 53 then reads its inclination relative to the horizontal. This angle corresponds to the elevation angle of the optical axis of the light unit.

In the embodiment represented, the gyroscopic platform used is a full inertial measurement system integrated into an electronic component. It measures six axes, namely three rotation axes and three acceleration measurement axes. An appropriate calibration, performed when putting the measuring apparatus into service, enables this gyroscope to indicate the inclination of the camera 53 with precision in a Galilean reference frame.

Besides, the image taken in this position by the camera 53 is analyzed to verify the precision of the transition between the colors red and white, and the chromatic characteristics of the colors.

It must be noted that the camera 53 comprises a motor-driven zoom element. It can be used efficiently both to identify the position of the light unit in order to enable the precise positioning of the case 51, with a relatively low magnification, and to take a precise image of the light unit enabling an analysis of its photometric and chromatic characteristics, with higher magnification.

### Measurements of Luminosity

Finally, the luminosity sensors fixed to the case can read the illumination at several points about the optical axis of the light unit 25. From the position of the case 51 in which the camera 53 is placed precisely on the optical axis of the light unit 25, the case 51 can be shifted by the motor-driven shifting system in order to shift the different luminosity sensors towards predetermined points around the optical axis of the light unit 25, in order to make several series of measurements of the illuminance. These measurements of luminosity can especially enable the computation of aperture angle the light unit 25 and make it possible to plot the isocandela diagram of the beam emitted in the white and red colors.

It must be noted that the measurements of luminosity given by the luminosity sensors 61 to 64 enable a far more precise measurement of the luminosity, with a far smaller risk of error than in the case of the camera.

### Data Processing

The different components involved in the measurement:
the camera 53 (providing the images);
system of automatic feedback control and checking of the motions of the camera 53, about the vertical axis and about the horizontal axis, and of the position of the zoom element (providing data corresponding to the angle of the camera and the position of the zoom lens);
the servomotors commanding the vertical and horizontal shifting of the case 51 along rails borne by the tripod 52 (giving data corresponding to the position of the camera);
the gyroscope fixed to the camera (providing data corresponding to the precise angular position of the camera relative to a preliminarily calibrated Galilean reference frame);
the luminosity sensors 61 to 64 borne by the case 51

are connected to one another by means of a local area network (LAN) providing fast and secured communication of the checking/control information as well as the collecting of the acquired data. All these pieces of data are converted into binary data by a converter placed in the case 51, and are sent by a WiFi communications module placed in the case 51 to a computer 7 enabling their processing and providing the interface with the operator.

### Checking Device

The device for checking an approach path indicator for the landing of an aircraft, according to the embodiment shown, comprises the measuring apparatus 5 and the computer 7 used to control the measuring apparatus 5 and process the data read by this apparatus.

FIG. 7 is a schematic representation of the architecture of this device. This figure represents the measuring apparatus 5 and the computer 7.

The measuring apparatus comprises the camera 51, which communicates its images to the converter 50. The servomotors associated with the camera 51, which control its pivoting and its zoom function, receive commands from the converter 50 and send it the information representing their position.

In the same way, the servomotors of the motor-driven shifting system 520 receive commands from the converter 50 and send it the information representing their position.

Finally, the gyroscopic platform 9 and the luminosity sensors 60 send the converter 50 the pieces of data that they measure.

The converter 50 converts all these pieces of data and sends them to the computer 7, which can for example be a portable computer placed in a vehicle in proximity to the measuring apparatus 5. These pieces of data received by the computer 7 are processed by a dedicated software program 70, which has access to a data base 71 comprising information on the light units to be checked, such as the name of the runway, the position of the light unit, its theoretical inclination etc. Besides, this software program enables the interactions with an operator by means of the man-machine interface 72 of the computer.

The operator can therefore perform the operations of checking a PAPI light unit, and especially check the operation of the measuring apparatus 5, by means of the man-machine interface 72 of the computer.

Using the information sent to it by the measuring apparatus 5, the software program 70 can determine the following parameters:
the elevation angle of each light unit of a PAPI system;
the angle of inclination of the color transition of each light unit relative to the horizontal;
the thickness in degrees of the transition between the colors red and white of each light unit of the PAPI system;
the diagram of intensity (or of luminance) of each light unit;
the diagram of chromaticity of each light unit.

From these parameters, the software program can compute the corrections to be made to the PAPI system and especially:
the inclination of the PAPI system in its entirety;
the optical quality and the alignment of the lenses;
the alignment of the red filters;
the alignment of the aperture of the elliptic reflectors;
the collimation (in elevation and in transition) of the light beams of each light unit;
the azimuth aperture angle of each light unit;
the parallelism of the beams of the light units relative to the axis of the runway:
the inclination along the longitudinal axis (also called the angle roll) of the PAPI system;
the inclination along the longitudinal axis (also called the angle roll) of each red filter.

An exemplary embodiment of the present disclosure enables a precise and speedy measurement of the characteristics of the light beams emitted by the light units of a PAPI device, in order to enable the efficient and precise setting of the characteristics of these units.

An embodiment enables a precise measurement of the characteristics of luminous intensity of the light units of the PAPI device.

Although the present disclosure has been described with reference to one or more examples, workers skilled in the art will recognize that changes may be made in form and detail without departing from the scope of the disclosure and/or the appended claims.

1. A mobile apparatus for measuring characteristics of a light beam emitted by a light unit, presenting at least two angular portions of different colors, said apparatus comprising:
a support that enables the position of a measuring set to vary, wherein the measuring set comprises a single orientable camera, equipped with a zoom element capable of taking at least two positions:
a first position of low magnification, offering a low magnification and a wide field angle, enabling detection of the position of the light unit to orient the camera precisely in its direction; and
a second position of high magnification enabling taking of an image of the light unit enabling an analysis of the characteristics of the light beam emitted by the light unit.

2. The mobile apparatus for measuring according to claim 1, wherein said measuring set comprises at least one inertial platform fixed to said camera, enabling its inclination to be measured.

3. The mobile apparatus for measuring according to claim 1, wherein said measuring set comprises at least one luminosity sensor distinct from said camera.

4. The mobile apparatus for measuring according to claim 1, wherein said measuring set comprises a case containing said camera.

5. The mobile apparatus for measuring according to claim 3, wherein said at least one luminosity sensor is placed on a telescopic bracket carried by said case.

6. The mobile apparatus for measuring according to claim 1, wherein said support is constituted by a stand carrying a system for the motor-driven shifting of said measuring set.

7. A device for checking a light unit comprising:
a mobile apparatus for measuring characteristics of a light beam emitted by a light unit, presenting at least two angular portions of different colors, said apparatus comprising a support that enables the position of a measuring set to vary, wherein the measuring set comprises a single orientable camera, equipped with a zoom element capable of taking at least two positions:
a first position of low magnification, offering a low magnification and a wide field angle, enabling detection of the position of the light unit to orient the camera precisely in its direction; and
a second position of high magnification enabling taking of an image of the light unit enabling an analysis of the characteristics of the light beam emitted by the light unit, and
a computer configured by software to process data from the mobile apparatus for measuring, and
an interface with an operator.

8. A device for checking according to claim 7, wherein said mobile apparatus for measuring and said computer communicate by a WiFi type radio link.

9. A device according to claim 7, wherein said computer is configured to access a database comprising information relating to each of the light units to be checked.
